(19) United States
(12) Patent Application Publication
(10) Pub. No.: US 2010/0313430 A1
(43) Pub. Date: Dec. 16, 2010

(54) METHOD FOR CONTROLLING REVERSAL OF A BLADE OF A BUSH CUTTER

(75) Inventors: Toshinari Yamaoka, Nanjing (CN); Fangjie Nie, Nanjing (CN); Wei Dong, Nanjing (CN); Qi Zhang, Nanjing (CN)

Correspondence Address: GREENBERG TRAURIG, LLP, 77 WEST WACKER DRIVE, SUITE 3100, CHICAGO, IL, 60601-1732, US

(73) Assignee: CHERVON LIMITED, Wanchai (HK)

(21) Appl. No.: 12/797,213

(22) Filed: Jun. 9, 2010

(30) Foreign Application Priority Data
Jun. 15, 2009 (CN) 200910032427.9

(51) Int. Cl. B23Q 5/10; A01D 34/82

(52) U.S. Cl. 30/276

(57) ABSTRACT

A method for controlling reversal of a blade of a bush cutter. The method functions by detecting a parameter of a motor with a control circuit and, when a user presses a reversal button, by causing the control circuit to control the motor not to reverse when the detected parameter, e.g., speed of the motor, is greater than or equal to a preset threshold and to control the motor to reversely rotate and drive the blade to reversely rotate when the detected parameter is less than the preset threshold.

### RELATED APPLICATION

This application claims the benefit of CN 200910032427.9 filed on Jun. 15, 2009 the disclosure of which is incorporated herein by reference in its entirety.

### BACKGROUND

The bush cutter as a garden tool can be used for cutting bushes, weeds, and other vegetation. Conventional bush cutters can be generally classified into internal combustion engine-driven bush cutters and motor-driven bush cutters. Most of the bush cutters are driven by internal combustion engines and are rather heavy, so motor-driven bush cutters are now more widely used.

Electric motor-driven bush cutter generally includes a motor, a cutting head, and a handle, wherein the cutting head includes a blade. An elongated rod is connected between the motor housing and the cutting head, the handle is fixed on the rod. The handle generally comprises two handle grips that are available for gripping by both hands of the user, and a switch is disposed on one of the handle grips. The rod has a rotating shaft therein which is connected with the motor at one end through a gear reducer mechanism and connected with the blade at the other end through a bevel gear mechanism. Therefore, the rotation motion of the motor is transmitted to the blade through the rotating shaft, and then the blade is driven to rotate.

When the bush cutter is used to cut some vegetation with long stems, such as vines, the blade of the bush cutter is easily tangled with the stems. In this case, it will be very dangerous if the operator clears the stems on the blade by hand. Therefore, some bush cutters are provided with a reversal button. When the blade is tangled, the operator can simply press the reversal button, and the blade will rotate reversely to make the stems that are wrapped around the blade automatically fall.

Although the above-mentioned bush cutter can solve such kind of problem, it also creates a potential risk during operation. When the stems that are wrapped around the blade need to be removed, the operator would first release the controlling trigger and then press the reversal button under normal operation. As usual, when the controlling trigger is released by the operator, the blade still rotates at high-speed due to inertia. If the reversal button is pressed at this moment, the blade will immediately rotate reversely. Once the blade is switched rapidly to rotate reversely from its high-speed forward-rotation state, an accident may occur in that the locking nut may become loosened with the result being that the blade sputters out as the blade is installed to the drive shaft with the locking nut. In addition, if the operator inadvertently presses the reversal button when the blade is cutting vegetation in the forward-rotation to make the blade reversely rotate quickly, the similar consequence may also occur.

### SUMMARY

The disclosed method provides for controlling reversal of the blade of a bush cutter so as to effectively avoid a risk due to the reversal motion of otherwise conventional bush cutters.

The method according to the invention for controlling reversal of a blade of a bush cutter includes pressing a power button to supply the bush cutter with a power source; detecting parameters of a motor with a control circuit; pressing the reversal button and, if the speed of the motor is greater than or equal to a preset threshold, the control circuit controls the motor not to reverse while, if the speed is less than the preset threshold, the control circuit controls the motor to reversely rotate and then drives the blade to reversely rotate.

According to the disclosed method for controlling reversal of the blade of a bush cutter, when the operator presses the reversal button, if the motor rotates at high speed, the control circuit controls the motor not to reverse, and only when the motor speed is less than the preset threshold, the control circuit controls the motor to reverse and drive the blade to reversely rotate. Since the blade is converted to reversely rotate at the lower speed, the insecurity accident that the locking nut is loosed and the blade is sputtered out can be eliminated.

### BRIEF DESCRIPTION OF THE DRAWINGS

The subject method will be further described with reference to the accompanying figures, in which:

FIG. 1 is a perspective view of a preferred embodiment of a bush cutter;

FIG. 2 is an enlarged view of the operating handle of the bush cutter in FIG. 1;

FIG. 3 is a circuit principle diagram of the control circuit of the bush cutter; and

FIG. 4 is a flow chart view of the control circuit of the bush cutter.

### DETAILED DESCRIPTION

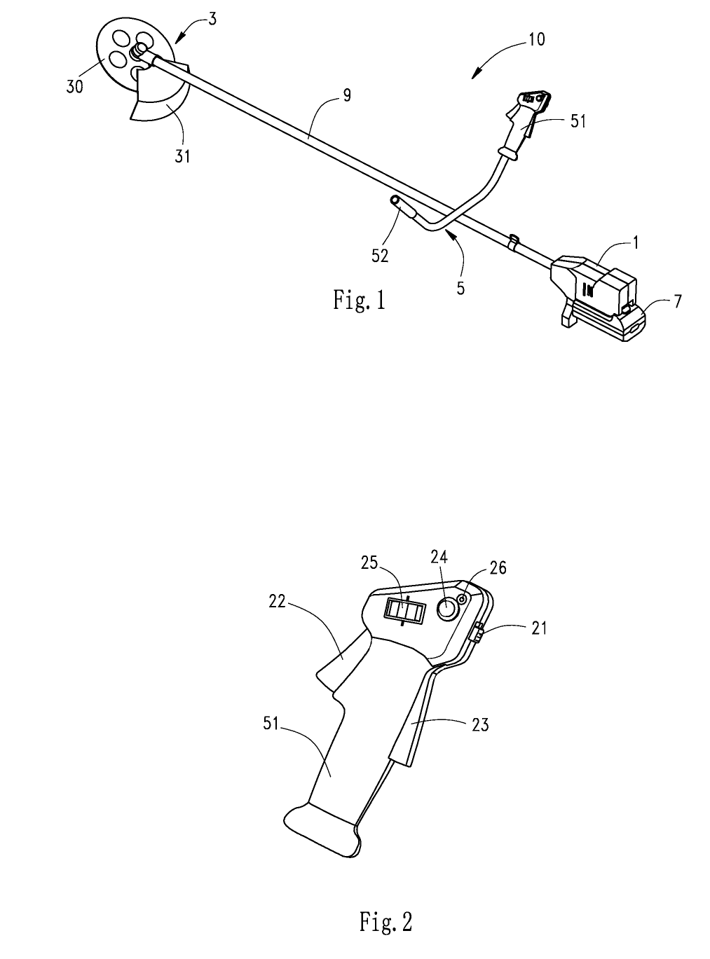

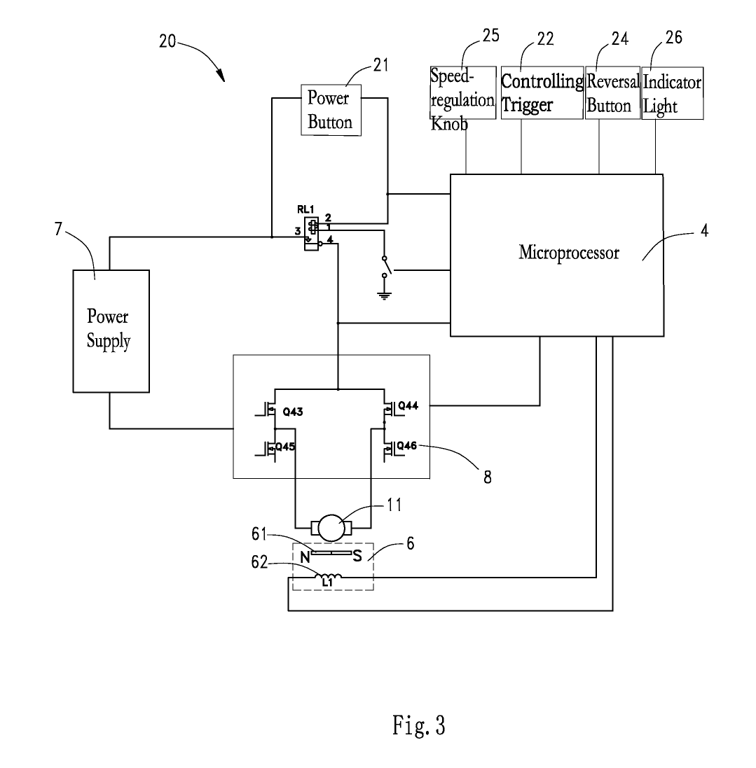

As shown in FIG. 1, the bush cutter 10 includes a motor housing 1, a cutting head 3, and a handle 5, wherein the cutting head 3 comprises a blade 30 and a shield 31 which partially covers the edge of the blade 30. A motor 11(shown in FIG. 3) is mounted in the motor housing 1. A battery pack 7 is mounted on the underside of the motor housing 1 for powering the motor 11. An elongated rod 9 is connected between the motor housing 1 and the cutting head 3 and the handle 5 is fixed on the rod 9. The handle 5 is generally U-shaped and comprises two handle grips, that is, a first handle grip 51 and a second handle grip 52, so that the user can operate the bush cutter by both hands. The rod 9 further has a rotating shaft therein (not shown) which is connected with the motor 11 at one end through a gear reducer mechanism and connected with the blade 30 at the other end through a bevel gear mechanism. Therefore, the rotation motion of the motor 11 is transmitted to the blade 30 through the rotating shaft, and then the blade 30 is driven to rotate. Such power transmission mechanism is well known to those skilled in the art.

As shown in FIG. 2, the first handle grip 51 is equipped with a plurality of switch devices including a power button 21, a controlling trigger 22, a safety switch 23, a reversal button 24, and a speed-regulation knob 25. In this way, the user can operate these switch means with the hand griping the first handle grip 51. On the first handle grip 51 a power indicator light 26 is mounted for indicating whether the bush cutter 10 is switched on or not. During operation of the bush cutter 10, the user must firstly press the power button 21 to power the motor 11 with the battery pack 7. Consequently, the power indicator light 26 is lighted to indicate that the power source is turned on. To prevent the user from accidentally operating the controlling trigger 22 so as to avoid an accident, an interlock mechanism is provided between the safety switch 23 and the controlling trigger 22, so that the motor 11 can be activated only when the user press the safety switch 23 and further triggers the controlling trigger 22, and then the blade 30 is driven to forwardly rotate. The speed-regulation knob 25 can be used to adjust the rotation speed of the motor 11.

The bush cutter 10 also includes a control circuit 20. As shown in FIG. 3, the control circuit 20 includes a microprocessor 4, a detection module 6, and a motor drive module 8, wherein the detection module 6 is used for detecting the parameters of the motor 11. In this embodiment, the detection module 6 is embodied as a speed measurement module used for detecting the rotation speed of the motor 11 and feeding back the detected speed to the microprocessor 4. The speed measurement module 6 includes a magnetic ring 61 and an inductor 62, and the magnetic ring 61 may rotate together with the motor 11. When the magnetic ring 61 rotates, the inductor 62 may induce the rotation speed signal and send a rotation speed signal to the microprocessor 4. The microprocessor 4 then compares the received rotation speed signal with a preset threshold. If the rotation speed signal is less than the threshold, then it can be determined that the blade 30 is approaching a stop in rotation. Otherwise, the blade 30 is in the rotation state. In this embodiment, the threshold is converted into the rotation speed of the blade at about 1.5 rev/sec. In other embodiments, the detection module can also detect other parameters of the motor 11 to obtain the speed of the motor, such as current, voltage, etc., and then these parameters can be fed back to the microprocessor 4 for this same purpose.

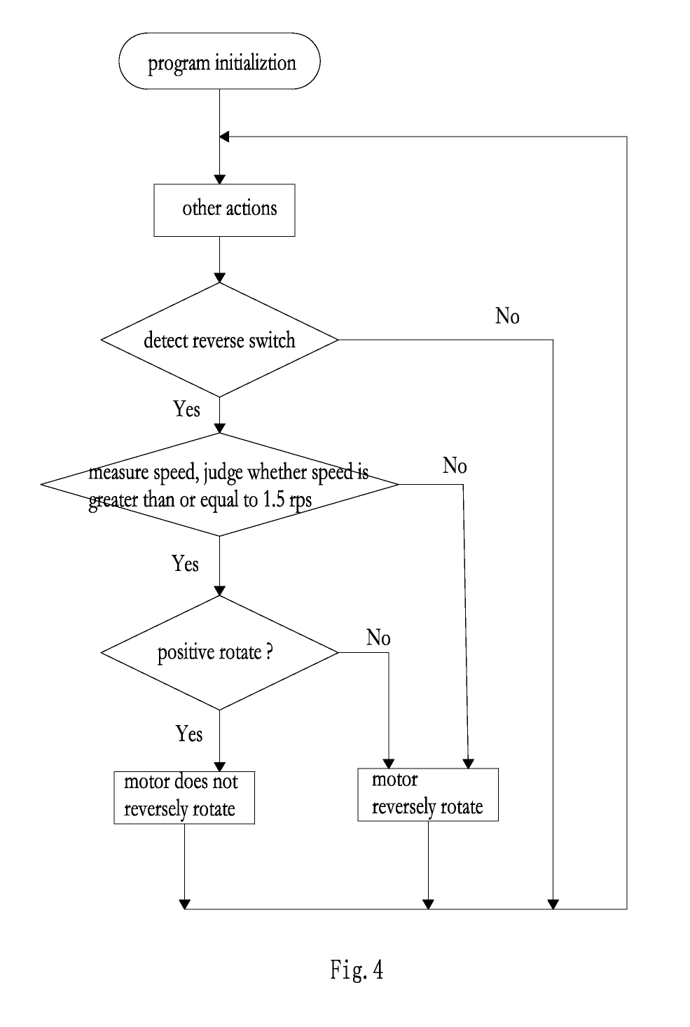

The control process of the control circuit 20 is shown in FIG. 4. When the power button 21 is pressed, the bush cutter 10 is powered by the power source, and the microprocessor 4 starts to detect the reversal switching, namely detect whether the reversal button 24 is pressed or not. If the reversal button 24 is in a pressed state, the speed measurement module 6 measures the speed of the motor 11 and feeds the detected speed back to the microprocessor 4. If the speed is less than the threshold, that is, if the speed of the blade 30 is less than 1.5 rev/sec, the motor 11 is controlled to rotate reversely. If the speed of the motor 11 is greater than or equal to the threshold, then the rotation direction of the motor 11 is continued to be detected, in this case, the control circuit 20 control the motor 11 not to rotate reversely if the motor 11 forwardly rotates at the moment, or the motor 11 is controlled to keep on rotating reversely if the motor 11 rotates reversely at the moment.

With the control circuit 20 and the working process thereof, when the reversal button 24 is pressed by the operator, the control circuit 20 will control the motor 11 not to reversely rotate if the blade 30 rotates forwardly and the speed is greater than or equal to 1.5 rev/sec and the motor 11 will reversely rotate only when the speed of the blade 30 is less than 1.5 rev/sec. As a result, the risk caused by suddenly reverse rotation of the blade during high-speed rotation can be effectively avoided.

The method of this invention for controlling reversal of the blade of the bush cutter is not limited to the contents mentioned above and the structures shown in the figures. For example, the bush cutter can also be powered by an AC power supply or the speed measurement module of the motor can adopt other measurement methods and, as such, need not be limited to the speed measurement with the magnetic ring and the inductor described. The scope of this invention is claimed in the appended claims. Any obvious modifications, substitutions, or changes to the shapes and the positions of other components based on the spirit of the present invention will be regarded as falling within the scope of this invention.

What is claimed is:

1. A method for controlling reversal of a blade of a bush cutter, comprising:
pressing a power button to supply the bush cutter with a power source;
detecting a parameter of a motor with a control circuit;
pressing a reversal button whereupon the control circuit will control the motor not to reversely rotate if the detected parameter is greater than or equal to a preset threshold and will control the motor to reversely rotate and drive the blade to reversely rotate if the detected parameter is less than the preset threshold.

2. A method for controlling reversal of the blade of the bush cutter as claimed in claim 1, wherein the preset threshold is converted into the rotation speed of the blade at about 1.5 rev/sec.

3. A method for controlling reversal of the blade of the bush cutter as claimed in claim 1, wherein the parameter of the motor detected by the control circuit is the speed of the motor.

4. A method for controlling reversal of the blade of the bush cutter as claimed in claim 1, wherein the control circuit includes the power source, the microprocessor, and the detection device.

5. A method for controlling reversal of the blade of the bush cutter as claimed in claim 4, wherein the detection device includes a magnetic ring and an inductor.
